(19) United States
(12) Patent Application Publication
(10) Pub. No.: US 2012/0233250 A1
(43) Pub. Date: Sep. 13, 2012

(54) AUTO-UPDATABLE DOCUMENT PARTS WITHIN CONTENT MANAGEMENT SYSTEMS

(75) Inventors: Kwai H. Man, Fremont, CA (US); Wai K. So, Daly City, CA (US)

(73) Assignee: INTERNATIONAL BUSINESS MACHINES CORPORATION, Armonk, NY (US)

(21) Appl. No.: 13/046,417

(22) Filed: Mar. 11, 2011

(51) Int. Cl. G06F 15/16

(52) U.S. Cl. 709/204

(57) ABSTRACT

Techniques are described for managing relationships between entities in a content management system. Embodiments of the invention identify a relationship between a first entity and a second entity in the content management system. Embodiments monitor the first entity in the content management system to detect an occurrence of a triggering event specified in one or more management rules. One or more actions specified by the one or more management rules are then performed on the second entity in the content management system, responsive to the detected occurrence of the triggering event.

### BACKGROUND

The present disclosure is directed to content management systems, and more particularly, to managing relationships between content in a content management system.

A content management system (also referred to herein as a “CMS”) is generally an application or collection of software components for managing workflow of multiple users in a collaborative environment. Content management systems may manage a variety of different types of data, including documents, video content, image content, and audio content. Additionally, CMSs may be used to store collections of data, such as employee information data and scientific test result data. As part of managing such data, content management systems may enable multiple users to collaborate in creating and/or editing a single data entity. For instance, a CMS may control the workflow of multiple users creating a single document managed by the CMS, so as to reduce repetitive input from the users, ensure contributions from the users are not omitted, and to more generally improve the collaborative process of creating the document. Additionally, the CMS may provide security restrictions, such as access control, to protect the data managed by the CMS.

### SUMMARY

Embodiments of the invention provide a method, computer program product and system for managing relationships between entities managed by a content management system. The method, computer program product and system include identifying a relationship between a first entity managed by the content management system and a second entity managed by the content management system. Additionally, the method, computer program product and system include providing a set of rules for managing the relationship between the first entity and the second entity, wherein each rule specifies at least (i) a triggering event and (ii) one or more actions to be performed responsive to an occurrence of the triggering event. The method, computer program product and system also include monitoring the first entity in the content management system to detect an occurrence of the triggering event associated with at least one rule in the set of rules. Furthermore, the method, computer program product and system include, upon detecting the triggering event associated with at least one rule has occurred with respect to the first entity, performing the corresponding one or more actions specified in the rule against the second entity managed by the content management system.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured with a content modification component, according to one embodiment of the present invention.

FIG. 2 is a diagram illustrating a relationship between documents in a content management system, according to one embodiment of the present invention.

FIG. 3 is a diagram illustrating relationships between entities in a content management system, according to one embodiment of the present invention.

FIG. 4 is a flow diagram illustrating a method for managing relationships between entities in a content management system, according to one embodiment of the present invention.

FIG. 5 is a flow diagram illustrating a method for managing relationships between entities in a content management system, according to one embodiment of the present invention.

FIG. 6 is a block diagram illustrating a client-server view of a computing environment, according to one embodiment of the present invention.

### DETAILED DESCRIPTION

Embodiments of the invention generally provide techniques for managing relationships between two or more entities in a content management system. Embodiments may determine a relationship exists between the two or more entities in the content management system. Additionally, a collection of rules may be provided for managing the relationship between the entities. Each rule may in turn specify a triggering event and one or more actions to be performed in response to an occurrence of the triggering event. Embodiments may then monitor each of the two or more entities, and upon detecting an occurrence of a triggering event for at least one of the rules with respect to a first one of the entities. Embodiments of the invention may perform the one or more actions specified by the rule for at least one of the other related entities in the content management system. Doing so allows users and administrators of the content management system to establish policies to efficiently manage relationships between entities in the content management system.

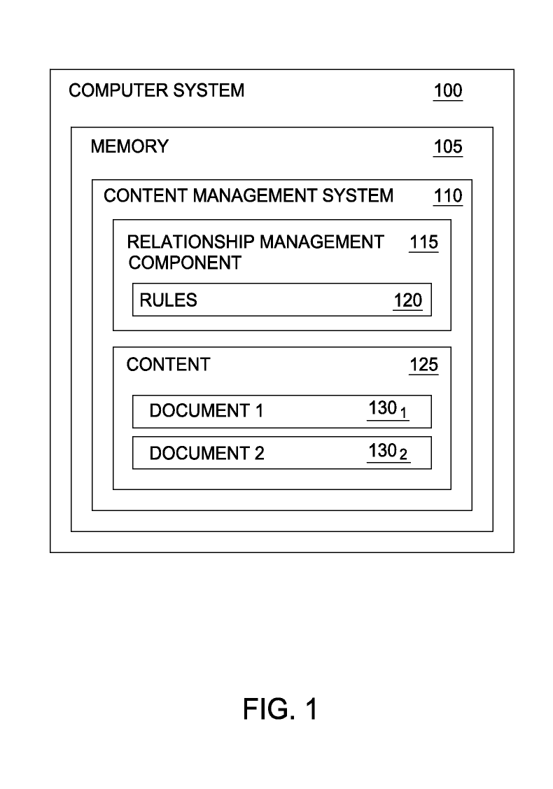

Referring now to FIG. 1, FIG. 1 is a block diagram illustrating a computer system configured with a content modification component, according to one embodiment of the present invention. As shown, the system 100 includes a memory 105, which contains a content management system 110 and content 125 managed by the content management system 110. The content management system 110 in turn contains a relationship management component 115. The relationship management component 115 includes a plurality of rules 120. In the depicted example, the managed content 125 includes two documents 130 managed by the content management system 110.

The rules 120 generally define actions to be taken based on relationships between content entities 125 managed by the content management system 110. As an example, a first rule 120 may specify that whenever a particular field in document 1 130₁ is modified, a corresponding field in document 2 130₂ should be correspondingly modified as well. In one embodiment of the invention, each rule may specify (i) a triggering event and (ii) one or more actions to be taken in response to an occurrence of the triggering event. In such an example, the relationship management component 115 may monitor a first content entity 125 (e.g., document 1 130₁) to detect occurrences of a triggering event specified by at least one of the rules. In response to detecting an occurrence of the triggering event, the relationship management component 115 may perform the one or more actions specified by each of the triggered rules against a second content entity 125 (e.g., document 2 130₂).

As an example, assume that Alice's car ran into Beth's car, and that insurance claim documents for both Alice and Beth are managed by the content management system 110. Further assume for this example that Alice's insurance claim document is represented by document 1 130₁ which indicates Alice was driving one type of car and Beth's insurance claim document is represented by document 2 130₂ which indicates Beth was driving a another. As the two documents 130 relate to the parties in the same car accident, a relationship between the two documents 130 is defined in the content management system 110. For instance, such a relationship may be defined by metadata associated with both of the documents 130. Such relationship metadata may be created, for instance, by an administrator of the content management system 110. In one embodiment, the relationship metadata may be created automatically by the content management system 110 based on an analysis of the two documents 130. For instance, if such an analysis reveals that both documents relate to an accident occurring at the same time, in the same place and with the same parties, the content management system 110 may determine that the documents 130 are related to one another.

Continuing the example, once the relationship between the documents 130 is defined, when Alice's insurance claim document 130₁ is edited (e.g., by a user of the content management system 110), such editing may trigger the triggering event of one or more rules 120. As discussed above, responsive to detecting an occurrence of the triggering event, the relationship management component 115 may perform one or more actions defined by the rule associated with the triggering event. For the present example, assume that one of the rules 120 specifies that duplicative content (i.e., content that occurs in both of the documents 130) should be updated in one of the documents 130, when the respective content in the other document 130 is updated.

Continuing the example, an insurance claims adjuster may edit Alice's insurance claim document 130₁ to indicate that Alice was cited for speeding at the time of the accident, and may further modify the document 130₁ to indicate that Alice was in driving a different type of car than was indicated in the initial report. The relationship management component 115 may detect that the editing of document 130₁ satisfies a triggering event of the example rule 120 for keeping related content up-to-date between the two documents 130. In response, the relationship management component 115 may perform actions specified by the rule against the second document 130₂.

For example, the actions specified by the rule 120 may include updating corresponding data elements in the second document 130₂. For instance, the relationship management component 115 may update a field pertaining to Alice's car in the second document 130₂ to include the value of the type of car set by the insurance adjuster in claim document 130₁. As another example, filters may be applied to the updated value as part of updating the second document 130₂. Generally, as used herein, filters refer to software modules configured to perform transformative operations on content within the content management system. For instance, the relationship management component 115 may use a filter to create a link to the section of Alice's insurance claim document 130₁ indicating that Alice was cited for speeding following the car accident and insert the created link into Beth's insurance claim document 130₂. Advantageously, by doing so, embodiments of the invention enable administrators and users of a content management system to efficiently manage relationships between content in the content management system.

Furthermore, the above examples are of course given without limitation and are provided for illustrative purposes only. Moreover, one of ordinary skill in the art will recognize that any number of other types of rules and content managed by a content management system may be used instead. More generally, any type of rule, as well as any content manageable by a content management system, capable of performing the functions described herein may be used consistent with embodiments of the invention.

As discussed above, a relationship management component 115 may monitor entities within the content management system 110 to detect triggering events specified in rules and perform actions on entities within the content management system 110 in response. For instance, another example rule could specify that when a user changes membership from one group to another, all documents owned by the user should be annotated to identify the user's new group membership. In one embodiment, such a rule may be specified and stored using a database. In another embodiment, the rule may be specified using extensible markup language (“XML”). For instance, Table 1 below shows an example of one XML formatting for representing such a rule.

TABLE 1
Rule Defined in XML

```
<rule>
    <condition>
        user_change_group
        <attr value=“userA”>
        </attr>
    </condition>
    <action>
        add_annotation
        <target>
            documents_of_user
        </target>
        <attr value=″new_group″>
        </attr>
    </action>
</rule>
```

As shown, the rule includes a condition (i.e., a triggering event) and an action to be taken responsive to an occurrence of the condition. Thus, in this example, the rule defines when a user (i.e., represented by the variable “userA”) changes groups (i.e., the condition “user_change_group”), an annotation should be added (i.e., shown by the action “add_annotation”) to all documents owned by the user (i.e., shown by the target “documents_of_user”) specifying the user's new group membership (i.e., shown by the variable “new_group”). Of course, such an example is given for illustrative purposes only, and one of ordinary skill in the art will quickly recognize that any number of different rules in varying formats may clearly be used in accordance with embodiments of the present invention.

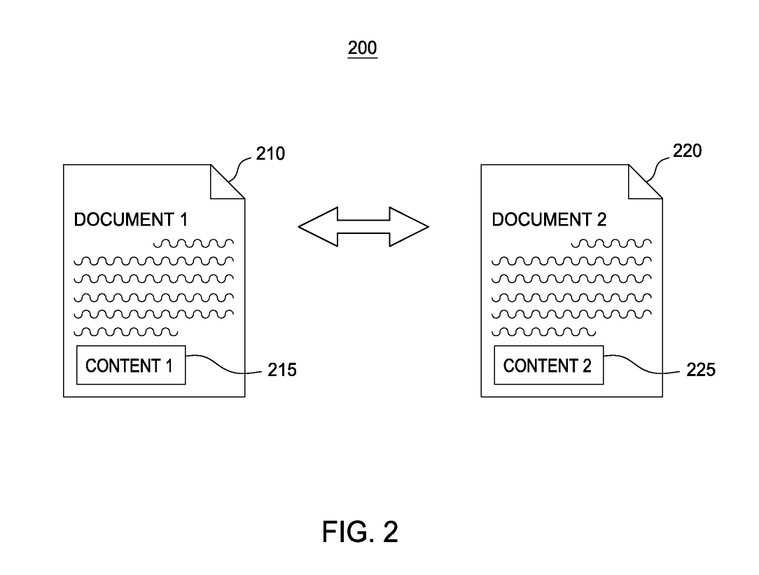

FIG. 2 is a diagram illustrating a relationship between documents in a content management system, according to one embodiment of the present invention. As shown, the diagram 200 includes a first document 210 containing content 1 215 and a second document 220 containing content 2 225. As discussed above, embodiments may monitor content managed by a content management system and manage relationships between the content based on one or more rules. As an example, a rule may specify that when modifications are made to content 1 215 in document 1 210, an annotation with a link to the modified section of content 1 215 should be added to content 2 225 in document 2 220. In such an example, when the relationship management component 115 detects that a user has added new content to document 1 210, the relationship management component 115 may apply one or more filters to the new content in order to create a link to the new content of document 1 210. The relationship management component 115 may then add an annotation to content 2 225 in document 2, which includes the created link to the new content of document 1 210. Advantageously, by doing this, embodiments of the invention may enable users and administrators of the content management system to efficiently manage relationships between content in the content management system using one or more defined rules.

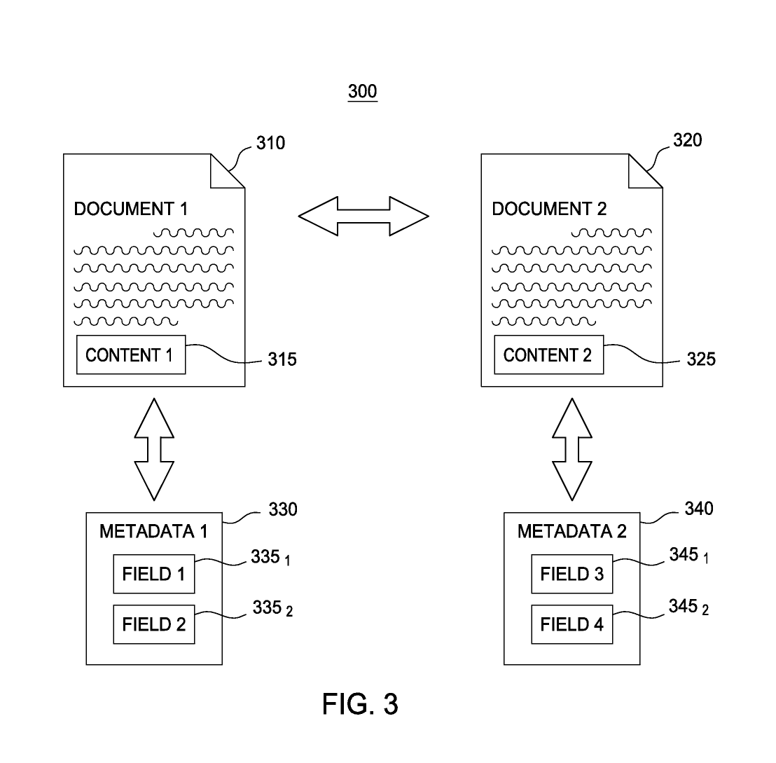

In addition to managing relationships between content managed by a content management system based on modifications to the content, embodiments of the invention may be configured to manage other relationships between entities in or associated with the content management system. FIG. 3 is a diagram illustrating relationships between entities in a content management system, according to one embodiment of the present invention. As shown, the diagram 300 includes documents 310 and 320 containing content 315 and 325, respectively. Additionally, the diagram 300 includes metadata 1 330 associated with the first document 310, and metadata 2 340 associated with the second document 320. Generally speaking, metadata 330 and 340 may be any data describing documents 310 and 320, respectively. For instance, field 1 335₁ of metadata 330 could be a timestamp indicating the last time document 310 was modified by a user of the content management system. As a second example, field 2 335₂ of metadata 330 could identify users who have access to modify the document 310.

As discussed above, a relationship management component 115 may monitor entities within the content management system to detect occurrences of triggering events associated with one or more rules. As an example, an administrator of the content management system could establish a rule which specifies that any time document 1 310 is modified, an entry reflecting the modification and a timestamp of the modification should be appended to document 2 320 in the content management system. In such an example, the relationship management component 115 could monitor the timestamp data in field 1 335₁ of metadata 330 to determine when the document 310 is modified. Upon detecting a modification to the document 310 (i.e., based on a change to the timestamp data in field 1 335₁), the relationship management component 115 could use one or more filters to create the entry reflecting the modification to document 310 and the timestamp indicating when the modification was made. Once the filters have created the entry, the relationship management component 115 could then append the created entry to document 320. Advantageously, by doing this, embodiments of the invention enable the administrator of the content management system to efficiently maintain relationships between the documents 310 and 320 in the content management system by keeping document 2 330 up-to-date, even when document 1 310 is modified by a user.

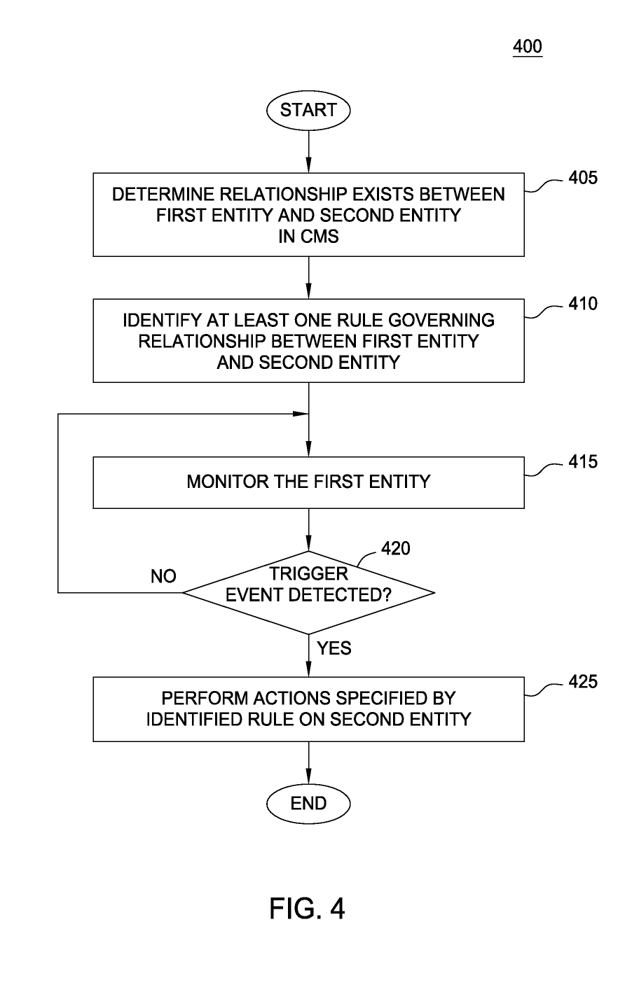

FIG. 4 is a flow diagram illustrating a method for managing relationships between entities in a content management system, according to one embodiment of the present invention. As shown, the method 400 begins at step 405, where the relationship management component 115 determines a relationship exists between a first entity and a second entity in a content management system. As an example, the first entity may be a first document in the content management system (e.g., document 210) and the second entity may be a second document in the content management system (e.g., document 220). Furthermore, as discussed above, other examples of managed entities include, without limitation, image content, audio content, video content and metadata managed by the content management system. In one embodiment of the invention, the relationship between the first entity and the second entity may be specified by a user.

According to another embodiment of the invention, the relationship management component 115 may analyze both the first entity and the second entity in the content management system to determine characteristics of each entity. The relationship management component 115 may then compare the determined characteristics for each entity and determine whether a relationship exists between the two entities. For instance, the relationship management component 115 may consider whether the two entities contain similar content when determining whether such a relationship exists. As an example, using the example given above of insurance claim documents in a content management system, if the relationship management component 115 determines that both insurance claim documents refer to the same parties, driving the same cars, at the same location and at the same point in time, the relationship management component 115 may determine a relationship exists between the two documents.

Additionally, the relationship management component 115 may consider metadata describing the two entities when determining whether a relationship exists between the entities. Examples of such metadata include, without limitation, which user(s) authored each of the entities, which groups control each of the entities, when each of the entities was created in the content management system, and so on. Furthermore, according to one embodiment of the present invention, the relationship management component 115 may generate a similarity value indicating the determined similarity between the two entities in the content management system. The relationship management component 115 could then compare the generated similarity value to a threshold level of similarity, and upon determining the generated similarity value exceeds the threshold level of similarity, the relationship management component 115 could determine a relationship exists between the two entities. Of course, all of the above examples are without limitation and are provided for illustrative purposes only. Furthermore, one of ordinary skill in the art will recognize that any number of other techniques may be used for determining whether a relationship exists between the two entities in the content management system, consistent with the functions described herein.

The relationship management component 115 then identifies at least one rule governing the relationship between the two entities (step 410). For purposes of the present example, assume that the identified rule specifies one or more actions that should be performed on the second entity in the content management system, responsive to a trigger event associated with the first entity in the content management system. As discussed above, such a rule may be defined using a markup language such as the extensible markup language (“XML”). Additionally, in one embodiment, such a rule may be stored in a database accessible by the relationship management component 115. Generally, each rule specifies at least a triggering event and one or more actions to be performed responsive to an occurrence of the triggering event. Furthermore, a rule may specify one or more filters to be used in performing the one or more actions. For instance, one such filter could be a software module that creates links to particular content within the content management system.

Continuing the depicted example, the relationship management component 115 then monitors the first entity in the content management system (step 415). Of note, although in the present example only the first entity in the content management system is monitored, of course one or more other entities within the content management system may be monitored in accordance with embodiments of the present invention. Likewise, certain triggering events associated with a particular rules may be satisfied by multiple entities within the content management system (i.e., as opposed to a triggering event tied to a single entity). In such a scenario, it follows that the relationship management component 115 may monitor multiple entities within the content management system in order to detect occurrences of the triggering event associated with such a rule.

Returning to the present example, the relationship management component 115 monitors the first entity in the content management system until an occurrence of the triggering event is detected. As shown, at step 420, the relationship management component 115 determines whether an occurrence of the triggering event is detected. If no occurrence was detected, the relationship management component 115 continues monitoring the first entity and the method 400 returns to step 415. If, instead, the relationship management component 115 detects an occurrence of the triggering event associated with the identified rule, the relationship management component 115 then performs one or more actions specified by the identified rule on the second entity in the content management system (step 425). As discussed above, such actions may include, for instance, updating content in the second entity, adding additional content to the second entity, deleting at least a portion of the content in the second entity, annotating the second entity, and so on. Once the actions are performed, the method 400 ends.

Advantageously, the method 400 enables users and administrators of a content management system to efficiently create and maintain relationships between entities in the content management system. That is, as content in a content management system often changes over time as users add, modify and delete portions of the content, it can be difficult to keep related documents in the content management system up-to-date. However, the method 400 enables users and administrators of the content management system to create rules which govern these relationships, and the relationship management component 115 may enforce these rules as content is added, modified and deleted in the content management system to ensure that these relationships are maintained and properly managed.

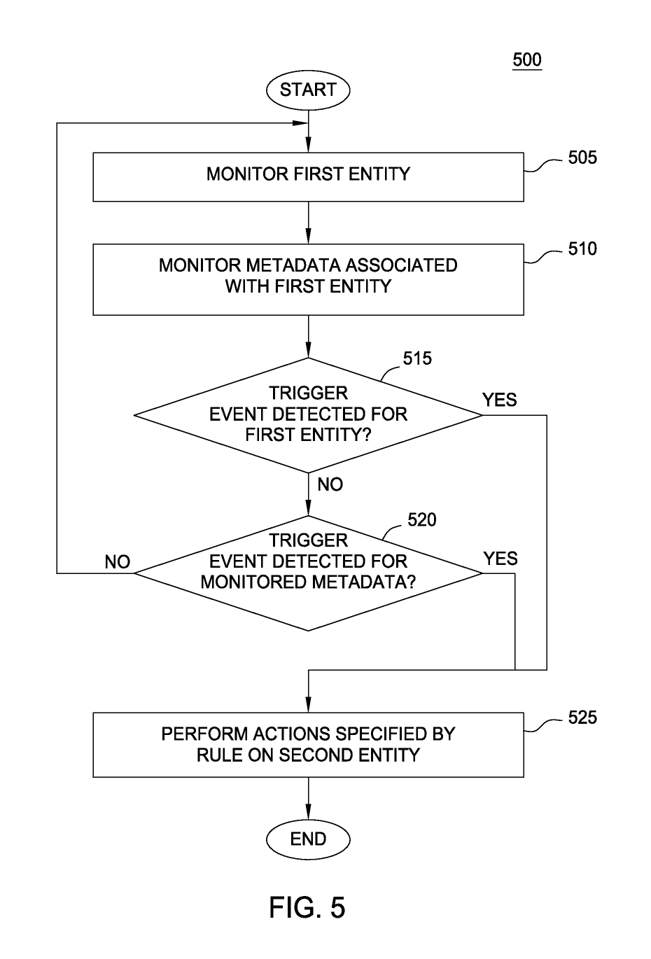

FIG. 5 is a flow diagram illustrating a method for managing relationships between entities in a content management system, according to one embodiment of the present invention. As shown, the method 500 begins at step 505, where the relationship management component 115 monitors a first entity in the content management system. Additionally, in the depicted example, the relationship management component 115 further monitors metadata associated with the first entity (step 510).

The relationship management component 115 then determines whether a triggering event associated with a rule has occurred with respect to the first entity based on the monitored actions (step 515). If not, the relationship management component 115 determines whether a triggering event has occurred with respect to the monitored metadata associated with the first entity (step 520). If no occurrence of a triggering event is detected for the monitored metadata, the method begins at step 505 where the relationship management component 115 continues monitoring the first entity.

If, instead, an occurrence of a triggering event is detected with respect to either the first entity or the metadata associated with the first entity, the relationship management component 115 performs one or more actions specified by the rule associated with the triggering event on a second entity in the content management system (step 525). Once the relationship management component 115 performs the specified actions, the method 500 ends. Advantageously, by monitoring both the first entity and the metadata associated with the first entity, the method 500 enables content management system administrators to create a broader array of rules for managing relationships between content in the content management system.

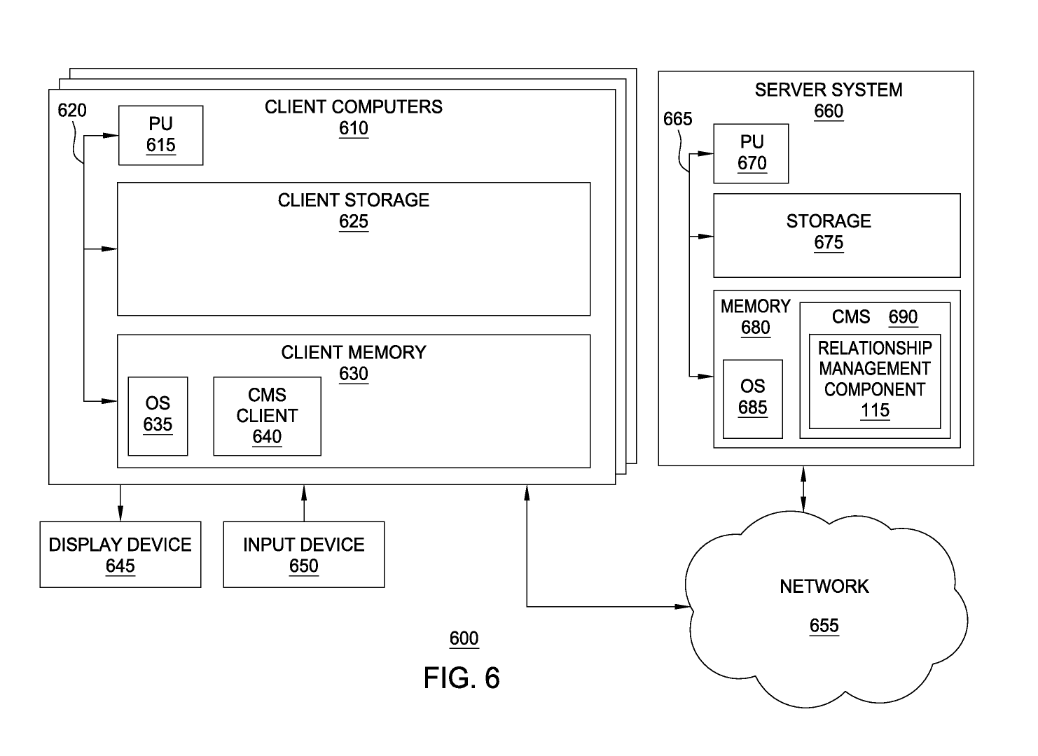

FIG. 6 is a block diagram illustrating a client-server view of a computing environment, according to one embodiment of the present invention. As shown, computing environment 600 includes client computers 610, a network 655, and a server system 660. In one embodiment, the environment 600 may include existing computer systems, e.g., desktop computers, server computers, laptop computers, tablet computers, gaming consoles, hand-held gaming devices and the like. The computing environment 600 illustrated in FIG. 6, however, is merely an example of one computing environment in which embodiments of the present invention may be used. Embodiments of the present invention may be implemented differently, regardless of whether the computer systems are complex multi-user computing systems, such as a cluster of individual computers connected by a high-speed network, single-user workstations, or network appliances lacking non-volatile storage. Further, while FIG. 6 illustrates a client-server model, other models are contemplated such as a peer-to-peer model.

As shown, each client computer 610 includes a processing unit 615, which obtains instructions and data via a bus 620 from a client memory 630 and client storage 625. Processing unit 615 is a programmable logic device that performs instruction, logic, and mathematical processing, and may be representative of one or more CPUs and/or GPUs. Client storage 625 stores application programs and data for use by client computer 610. The memory 630 is any memory sufficiently large to hold the necessary programs and data structures. Memory 630 could be one or a combination of memory devices, including Random Access Memory, nonvolatile or backup memory (e.g., programmable or Flash memories, read-only memories, etc.). In addition, memory 630 and storage 625 may be considered to include memory physically located elsewhere; for example, on another computer coupled to the client computer 610 via bus 620.

Client storage 625 includes hard-disk drives, flash memory devices, optical media and the like. Client computer 610 is operably connected to the network 655. Client memory 630 includes an operating system (OS) 635 and a content management system client 640. Operating system 635 is the software used for managing the operation of the client computer 610. Examples of OS 635 include UNIX, a version of the Microsoft Windows® operating system, and distributions of the Linux® operating system. (Note: Linux is a trademark of Linus Torvalds in the United States and other countries.)

In one embodiment, each client is a general purpose computer configured to run any variety of applications including the CMS client 640. A graphical user interface for the CMS client 640 may be viewed on a display device 645, such as an LCD, LED or CRT monitor display, and controlled using input devices 650 which may be, e.g., a keyboard, mouse and/or a controller.

As shown, the server system 660 includes the same basic hardware elements as the client computers 610. Specifically, the server system 660 includes a processing unit 670 (representative of one or more CPUs and/or GPUs), a memory 680 and storage 675 connected via a bus 665. The server system 660 may be operably connected to the network 655, which generally represents any kind of data communications network. Accordingly, the network 655 may represent both local and wide area networks, including the Internet. In one embodiment, the server system 660 hosts a content management system 690 to which one or more of the client computers 610 connect using a CMS client 640. The content management system 690 includes a relationship management component 115, which generally manages relationships between entities in the content management system 690 based on one or more rules. Each rule, in turn, may include a triggering event and a trigger condition, the trigger condition specifying one or more actions to be performed in response to an occurrence of the triggering event.

It is specifically contemplated that embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Cloud computing resources may be provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., the content management system 690) or related data available in the cloud. For example, the content management system 690 could execute on a computing system in the cloud and a relationship management component 695 within the content management system 690 could manage relationships between content managed by the content management system 690. In such a case, the relationship management component 695 could detect the occurrence of a triggering event with respect to a first entity in the content management system 690, and could perform one or more actions specified by one or more rules on a second entity in the content management system 690. Doing so allows users and content management system administrators to manage and control relationships between content in the content management system from any computing system attached to a network connected to the cloud (e.g., the Internet).

In the preceding, reference is made to embodiments of the invention. However, it should be understood that the present disclosure is not limited to specific described embodiments. Instead, any combination of the following features and elements, whether related to different embodiments or not, is contemplated to implement and practice the disclosure. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present invention, other and further embodiments of the invention may be devised without departing from the basic scope thereof, and the scope thereof is determined by the claims that follow.

1.-8. (canceled)

9. A computer program product for managing relationships between entities managed by a content management system, comprising:
a computer-readable storage medium having computer readable program code embodied therewith, the computer readable program code comprising:
computer readable program code to identify a relationship between a first entity managed by the content management system and a second entity managed by the content management system;
computer readable program code to provide a set of rules for managing the relationship between the first entity and the second entity, wherein each rule specifies at least (i) a triggering event and (ii) one or more actions to be performed responsive to an occurrence of the triggering event;
computer readable program code to monitor the first entity in the content management system to detect an occurrence of the triggering event associated with at least one rule in the set of rules; and
computer readable program code to, upon detecting the triggering event associated with at least one rule has occurred with respect to the first entity, perform the corresponding one or more actions specified in the rule against the second entity managed by the content management system.

10. The computer program product of claim 9, wherein at least one of the first entity and the second entity comprises metadata associated with a content object managed by the content management system.

11. The computer program product of claim 9, wherein at least one of the first entity and the second entity comprises one of a document, an image, audio content, and video content.

12. The computer program product of claim 9, wherein the computer readable program code to perform the corresponding one or more actions specified in the rule against the second entity managed by the content management system further comprises:
computer readable program code to identify content associated with the first entity managed by the content management system that was modified by the triggering event;
computer readable program code to apply one or more filters to the identified content associated with the first entity to create transformed content;
computer readable program code to modify the second entity managed by the content management system based on the transformed content.

13. The computer program product of claim 9, wherein at least one of the set of rules is specified using extensible markup language (“XML”).

14. The computer program product of claim 9, wherein one of the corresponding one or more actions for at least one of the rules comprises updating at least one of metadata associated with the second entity and second content associated with the second entity, based on modifications to first content associated with the first entity.

15. The computer program product of claim 9, wherein determining a relationship exists between a first entity in the content management system and a second entity in the content management system further comprises receiving a request from a user specifying the relationship between the first entity managed by the content management system and the second entity managed by the content management system.

16. The computer program product of claim 9, wherein the computer readable program code to determine a relationship exists between a first entity managed by the content management system and a second entity managed by the content management system further comprises:
computer readable program code to analyze the first entity managed by the content management system to determine a first one or more characteristics of the first entity;
computer readable program code to analyze the second entity managed by the content management system to determine a second one or more characteristics of the second entity; and
wherein the relationship between the first entity and the second entity is determined based on the both the first one or more characteristics of the first entity and the second one or more characteristics of the second entity.

17. A system, comprising:
a computer processor; and
a memory containing a program that, when executed on the computer processor, performs an operation for managing relationships between entities managed by a content management system, comprising:
identifying a relationship between a first entity managed by the content management system and a second entity managed by the content management system;
providing a set of rules for managing the relationship between the first entity and the second entity, wherein each rule specifies at least (i) a triggering event and (ii) one or more actions to be performed responsive to an occurrence of the triggering event;
monitoring the first entity in the content management system to detect an occurrence of the triggering event associated with at least one rule in the set of rules; and
upon detecting the triggering event associated with at least one rule has occurred with respect to the first entity, performing the corresponding one or more actions specified in the rule against the second entity managed by the content management system.

18. The system of claim 17, wherein at least one of the first entity and the second entity comprises metadata associated with a content object managed by the content management system.

19. The system of claim 17, wherein at least one of the first entity and the second entity comprises one of a document, an image, audio content, and video content.

20. The system of claim 17, wherein performing the corresponding one or more actions specified in the rule against the second entity managed by the content management system further comprises:
identifying content associated with the first entity managed by the content management system that was modified by the triggering event;
applying one or more filters to the identified content associated with the first entity to create transformed content;
modifying the second entity managed by the content management system based on the transformed content.

21. The system of claim 17, wherein at least one of the set of rules is specified using extensible markup language (“XML”).

22. The system of claim 17, wherein one of the corresponding one or more actions for at least one of the rules comprises updating at least one of metadata associated with the second entity and second content associated with the second entity, based on modifications to first content associated with the first entity.

23. The system of claim 17, wherein determining a relationship exists between a first entity in the content management system and a second entity in the content management system further comprises receiving a request from a user specifying the relationship between the first entity managed by the content management system and the second entity managed by the content management system.

24. The system of claim 17, wherein determining a relationship exists between a first entity managed by the content management system and a second entity managed by the content management system further comprises:
analyzing the first entity managed by the content management system to determine a first one or more characteristics of the first entity;
analyzing the second entity managed by the content management system to determine a second one or more characteristics of the second entity; and
wherein the relationship between the first entity and the second entity is determined based on the both the first one or more characteristics of the first entity and the second one or more characteristics of the second entity.

25. (canceled)
